(19) United States
(12) Patent Application Publication
(10) Pub. No.: US 2022/0018524 A1
(43) Pub. Date: Jan. 20, 2022

(54) ROTATABLE LAMP HANGER

(71) Applicant: SHEN ZHEN LAMHO PHOTOELECTRICITY & TECHNOLOGY CO., LTD., Shenzhen (CN)

(72) Inventor: Taohua Xiong, Fuzhou (CN)

(21) Appl. No.: 17/449,330

(22) Filed: Sep. 29, 2021

(51) Int. Cl. F21V 21/104; F21V 21/14; F21V 21/112

(52) U.S. Cl. CPC F21V 21/104; F21V 21/112; F21V 21/14

(57) ABSTRACT

The invention discloses a rotatable lamp hanger, including a fixed seat and a rotatable seat rotatably connected to the fixed seat, wherein a lamp is disposed on the rotatable seat, and the fixed seat or the rotatable seat is provided with a mounting cavity, in which a drive unit is disposed; and further including a power supply that supplies power to the drive unit and the lamp, wherein when the drive unit works, the lamp is rotated under the drive of the rotatable seat that is driven by the drive unit. In this way, with the design of the rotatable lamp hanger, the technical problem of low ornamental value of a ceiling lamp at rest in the prior art is solved.

### BACKGROUND OF THE INVENTION

### 1. Technical Field

The invention relates to the field of decorative ceiling lamps, and in particular, relates to a rotatable lamp hanger.

### 2. Description of Related Art

As the modern society evolves, people have increasingly high requirements for indoor decoration. There is an existing decorative lamp that is hung on an indoor ceiling. However, such a decorative lamp has the defect of low ornamental value since an existing decorative ceiling lamp has no auto-rotation function and keeps still in the air.

Therefore, there is a need of developing a new technical solution to solve the problem described above.

### BRIEF SUMMARY OF THE INVENTION

In order to overcome the above defect and shortcoming in the prior art, the invention provides a rotatable lamp hanger, which overcomes the defect in the prior art that a ceiling lamp fails to work normally due to the breakage of a power cord caused by the rotation of the ceiling lamp, increases the ornamental value of the decorative ceiling lamp, and is in line with the aesthetic trend of modern people.

To achieve the object above, the invention employs the following technical solution: a rotatable lamp hanger includes a fixed seat and a rotatable seat rotatably connected to the fixed seat, wherein a lamp is disposed on the rotatable seat, and the fixed seat or the rotatable seat is provided with a mounting cavity, in which a drive unit is disposed;

and further including a power supply that supplies power to the drive unit and the lamp, wherein when the drive unit works, the lamp is rotated under the drive of the rotatable seat that is driven by the drive unit.

Preferably, the mounting cavity is disposed in the fixed seat, the rotatable seat is disposed on a lower end of the fixed seat, and the lamp is disposed on a lower end of the rotatable seat; wherein

the drive unit includes a master control board and a motor that is controlled by and connected to the master control board, and the motor drives and is connected to the rotatable seat, such that the rotatable seat is rotatably disposed relative to the fixed seat; the power supply is an external power supply and is electrically connected to the master control board; and the master control board is electrically connected to the lamp.

Preferably, a first conductive element is disposed on the master control board, a second conductive element is disposed on the rotatable seat, and the lamp is electrically connected to the second conductive element; and wherein

the first conductive element is strip-shaped, the second conductive element is an annularly extending conductive element, the first conductive element is in butted contact with the second conductive element, and the first conductive element moves along an extending direction of the second conductive element when the rotatable seat rotates;

or, the first conductive element is an annularly extending conductive element, the second conductive element is strip-shaped, the first conductive element is in butted contact with the second conductive element, and the second conductive element moves along an extending direction of the first conductive element when the rotatable seat rotates.

Preferably, when the first conductive element is strip-shaped and the second conductive element is the annularly extending conductive element, the first conductive element includes a first conductive piece and a second conductive piece which are disposed at an interval; the second conductive piece includes a first conductive ring and a second conductive ring which are concentrically disposed; and the first conductive piece comes into contact with the first conductive ring and moves along an extending direction of the first conductive ring, and the second conductive piece comes into contact with the second conductive ring and moves along an extending direction of the second conductive ring; and

when the first conductive element is the annularly extending conductive element and the second conductive element is strip-shaped, the first conductive element includes a third conductive ring and a fourth conductive ring which are concentrically disposed; the second conductive piece includes a third conductive piece and a fourth conductive piece; and the third conductive piece comes into contact with the third conductive ring and moves along an extending direction of the third conductive ring, and the fourth conductive piece comes into contact with the fourth conductive ring and moves along an extending direction of the fourth conductive ring.

Preferably, a first conducting-wire hole is formed in the fixed seat, and the external power supply supplies power to and is connected to the master control board by passing a conducting wire through the first conducting-wire hole.

Preferably, a second conducting-wire hole is formed in the rotatable seat, and the second conductive element is connected to the lamp by passing a conducting wire through the second conducting-wire hole.

Preferably, the fixed seat includes a first housing and a second housing, and the first housing and the second housing are connected by ultrasonic welding or by a buckle or by a screw to form the mounting cavity.

Preferably, the mounting cavity is disposed in the rotatable seat, the rotatable seat is disposed on a lower end of the fixed seat, and the lamp is disposed on a lower end of the rotatable seat; wherein

the drive unit includes a motor, and a drive end of the motor is fixedly connected to the fixed seat, such that the rotatable seat is rotatably disposed relative to the fixed seat;

and the power supply includes an accumulator battery disposed within the mounting cavity, and the accumulator battery supplies power to and is connected to the motor and the lamp; and a wire outlet is formed in the rotatable seat, and the accumulator battery is connected to the lamp by passing a conducting wire through the wire outlet.

Preferably, the rotatable seat includes an upper housing and a cover that is detachably connected to a lower end of the upper housing, and the lamp is disposed on the cover.

Preferably, the mounting cavity is disposed in the fixed seat, the rotatable seat is disposed on a lower end of the fixed seat, and the lamp is disposed on a lower end of the rotatable seat; wherein

the drive unit includes a motor, which drives and is connected to the fixed seat, such that the rotatable seat is rotatably disposed relative to the fixed seat; and the power supply is an accumulator battery, and supplies power to and is connected to the motor and the lamp.

The invention has significant advantages and beneficial effects as compared with the prior art. Specifically, as can be known from the technical solutions above, the technical problem of low ornamental value of the ceiling lamp at rest in the prior art is solved mainly by designing a rotatable lamp hanger.

Then, the plurality of specific designs of the rotatable lamp hanger according to the invention solve the technical problem that the ceiling lamp during rotating causes the power cord to break; and furthermore, the invention is ingenious in structure, high in stability and easy to implement, which is conducive to popularization and application, showing considerable market prospects.

In order to set forth the structural features and functions of the invention more clearly, the invention will be illustrated in detail below in conjunction with the accompanying drawings and specific embodiments.

### BRIEF DESCRIPTION OF THE SEVERAL VIEWS OF THE DRAWINGS

FIG. 1 illustrates Embodiment 1 according to the invention;

FIG. 2 is a schematic perspective view of Embodiment 1 according to the invention;

FIG. 3 is a schematic perspective view of Embodiment 1 from another point of view according to the invention;

FIG. 4 is a schematic exploded view of Embodiment 1 according to the invention;

FIG. 5 is a partially enlarged view of FIG. 4;

FIG. 6 is a schematic perspective view of Embodiment 2 according to the invention; and

FIG. 7 is a schematic sectional view of Embodiment 2 according to the invention.

Reference signs are illustrated as follows:

10, fixed seat; 101, first housing; 102, second housing; 11, first conducting-wire hole; 20, rotatable seat; 201, upper housing; 202, cover; 203, first seal ring; 21, second conducting-wire hole; 22, wire outlet; 30, mounting cavity; 31, master control board; 32, motor; 33, first conductive element; 331, first conductive piece; 332, second conductive piece; 34, second conductive element; 341, first conductive ring; 342, second conductive ring; 35, power button; 40, first speed-reducing ring; 50, accumulator battery; 60, hook.

### DETAILED DESCRIPTION OF THE INVENTION

The technical solutions in the embodiments of the invention will be described clearly and completely below in conjunction with the accompanying drawings. Obviously, the embodiments described are merely preferred embodiments of the invention.

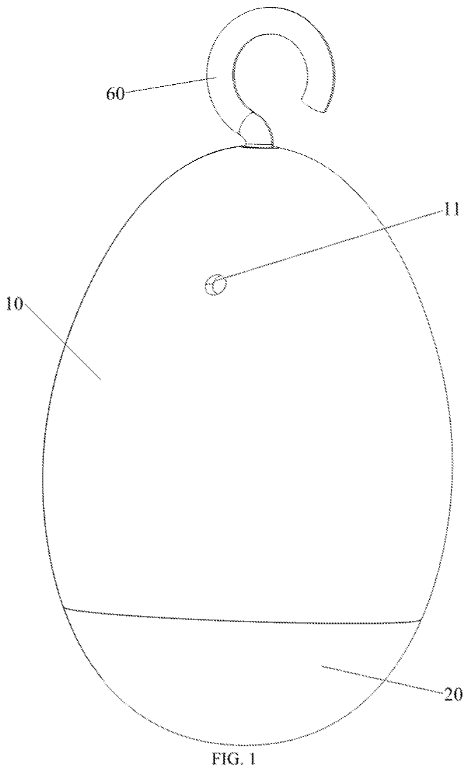

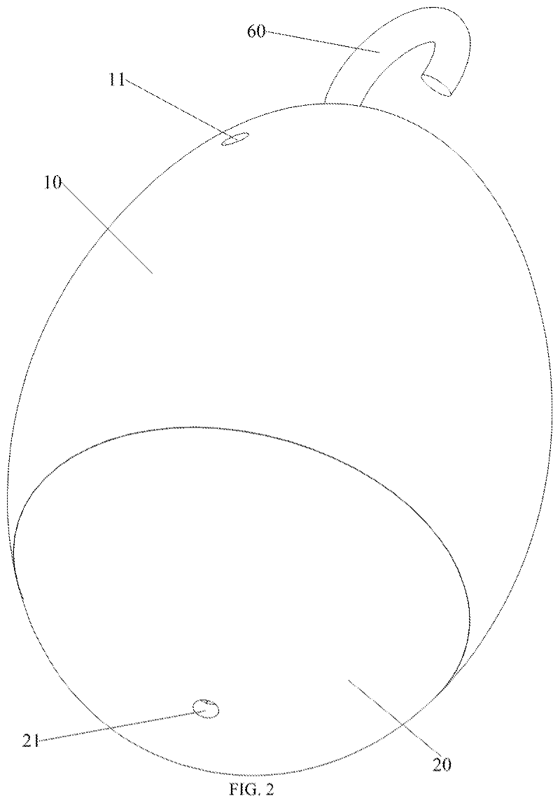

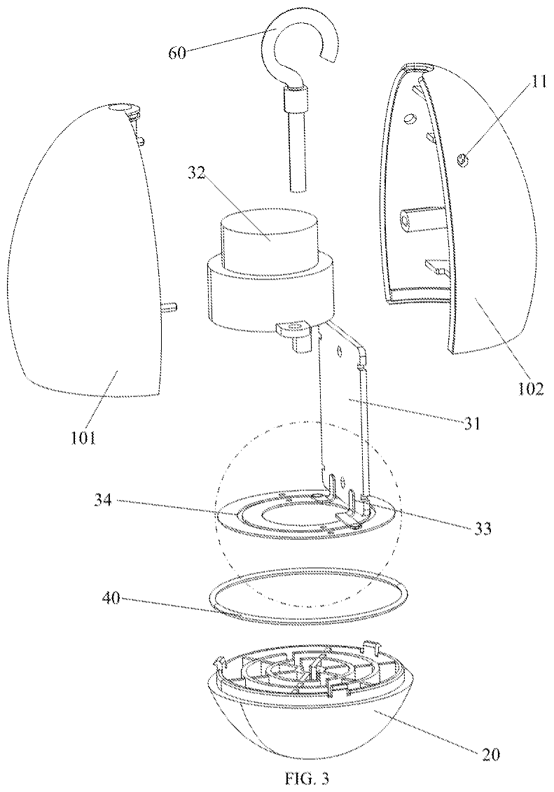

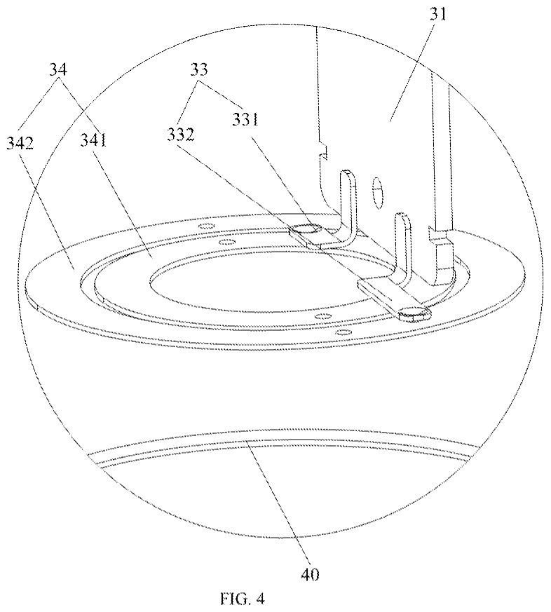

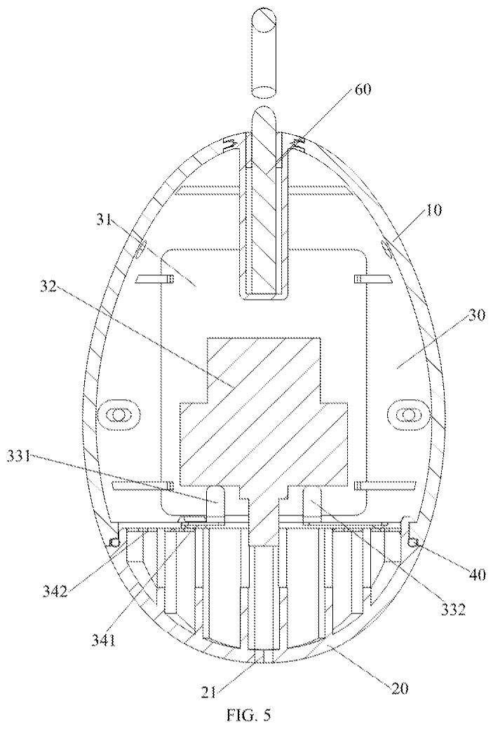

Referring to FIG. 1 to FIG. 7, the specific structures of three embodiments according to the invention are shown. A rotatable lamp hanger includes a fixed seat 10 and a rotatable seat 20 rotatably connected to the fixed seat 10; a lamp is disposed on the rotatable seat 20; the fixed seat 10 or the rotatable seat 20 is provided with a mounting cavity 30, in which a drive unit is disposed.

Moreover, the rotatable lamp hanger further includes a power supply that supplies power to the drive unit and the lamp. When the drive unit works, the lamp is rotated under the drive of the rotatable seat 20 that is driven by the drive unit.

Specifically, referring to FIG. 1 to FIG. 5, the specific structures of Embodiment 1 of the invention are shown. The mounting cavity 30 is disposed in the fixed seat 10; the rotatable seat 20 is disposed on a lower end of the fixed seat 10; and the lamp is disposed on a lower end of the rotatable seat 20.

Here, the drive unit includes a master control board 31 and a motor 32 that is controlled by and connected to the master control board 31, and the motor 32 drives and is connected to the rotatable seat 20, such that the rotatable seat 20 is rotatably disposed relative to the fixed seat 10; the power supply is an external power supply and is electrically connected to the master control board 31; and the master control board 31 is electrically connected to the lamp. Without doubt, the master control board 31 may be further electrically connected to an accumulator battery, which is charged by the external power supply.

Moreover, an upper end of the fixed seat 10 is further provided with a hook 60 for a hanging purpose, and the fixed seat 10 is hung in the air through the hook 60.

Further, a first conductive element 33 is disposed on the master control board 31, a second conductive element 34 is disposed on the rotatable seat 20, and the lamp is electrically connected to the second conductive element 34.

Here, the first conductive element 33 is strip-shaped, the second conductive element 34 is an annularly extending conductive element, the first conductive element 33 is in butted contact with the second conductive element 34, and the first conductive element 33 moves along an extending direction of the second conductive element 34 when the rotatable seat 20 rotates. Specifically, the first conductive element 33 is L-shaped, and a lower end of the first conductive element 33 is provided with a metal contract that comes into contact with the second conductive element 34.

Or, the first conductive element 33 is an annularly extending conductive element, the second conductive element 34 is strip-shaped, the first conductive element 33 is in butted contact with the second conductive element 34, and the second conductive element 34 moves along an extending direction of the first conductive element 33 when the rotatable seat 20 rotates.

As schematically shown in the accompanying drawings, the first conductive element 33 is strip-shaped and the second conductive element 34 is the annularly extending conductive element. Specifically, when the first conductive element 33 is strip-shaped and the second conductive element 34 is the annularly extending conductive element, the first conductive element 33 includes a first conductive piece 331 and a second conductive piece 332 which are disposed at an interval; the second conductive piece 34 includes a first conductive ring 341 and a second conductive ring 342 which are concentrically disposed; and the first conductive piece 331 comes into contact with the first conductive ring 341 and moves along an extending direction of the first conductive ring 341, and the second conductive piece 332 comes into contact with the second conductive ring 342 and moves along an extending direction of the second conductive ring 342.

Without double, there is another case. When the first conductive element 33 is the annularly extending conductive element and the second conductive element 34 is strip-shaped, the first conductive element 33 includes a third conductive ring and a fourth conductive ring which are concentrically disposed; the second conductive piece 34 includes a third conductive piece and a fourth conductive piece; and the third conductive piece comes into contact with the third conductive ring and moves along an extending direction of the third conductive ring, and the fourth conductive piece comes into contact with the fourth conductive ring and moves along an extending direction of the fourth conductive ring. The first conductive element 33 and the second conductive element 34 are generally made of a conductive metal material. It should be added that the description that the first conductive element 33 or the second conductive element 34 is strip-shaped is not to specifically limit the shape of the first conductive element 33 or the second conductive element 34, and it is enough as long as both the first conductive element 33 and the second conductive element 34 come into contact with each other in the form described above. For example, when the first conductive element 33 or the second conductive element 34 is strip-shaped, the first conductive element 33 or the second conductive element 34 may also be a sliding contact component such as a spring probe, a metal elastic piece or a carbon brush.

Preferably, a first speed-reducing ring 40 is disposed between the fixed seat 10 and the rotatable seat 20; the first speed-reducing ring 40 is made of rubber of a damping material for increasing a frictional force between the fixed seat 10 and the rotatable seat 20, thereby reducing the rotating speed of the rotatable seat 20 and reducing an abrasion between the first conductive element 33 and the second conductive element 34. Meanwhile, the operating stability of the rotatable lamp hanger is ensured, and the safety in use is improved.

Further, a first conducting-wire hole 11 is formed in the fixed seat 10, and the external power supply supplies power to and is connected to the master control board 31 by passing a conducting wire through the first conducting-wire hole 11. Meanwhile, it should be added that the master control board 31 may also be electrically connected to a conducting wire, which is connected to other lamps in series by passing through a first conducting-wire hole 11. Further, a second conducting-wire hole 21 is formed in the rotatable seat 20; the second conductive element 34 is connected to the lamp by passing the conducting wire through the second conducting-wire hole 21; and the rotatable seat 20 is provided with an escape groove at a position corresponding to the conducting wire.

Preferably, the fixed seat 10 includes a first housing 101 and a second housing 102, and the first housing 101 and the second housing 102 are ultrasonically welded to form the mounting cavity 30. Specifically, both the first housing 101 and the second housing 102 are arc-shaped, and are connected through a buckle structure and then fixed by ultrasonic welding. Without doubt, the first housing 101 and the second housing 102 may also be directly bucked and connected by a buckle, or connected by a thread. Meanwhile, a first clamping position and a second clamping position for clamping the motor 32 and the master control board 31 are correspondingly disposed in the mounting cavity 30.

Further, a drive end of the motor 32 is of a non-circular structure; the rotatable seat 20 is provided with a matched non-circular slot at a position corresponding to the drive end of the motor 32; and the drive end of the motor 32 is inserted into the non-circular slot and then fixed by glue. Preferably, the master control board 31 is correspondingly provided with an infrared receiving module or a wireless receiving module, such that a user may control the on or off of the rotatable lamp hanger (and the lamp) by a remote controller or a mobile phone.

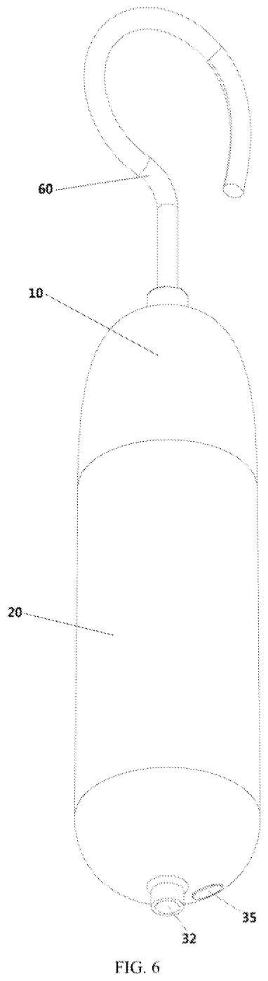

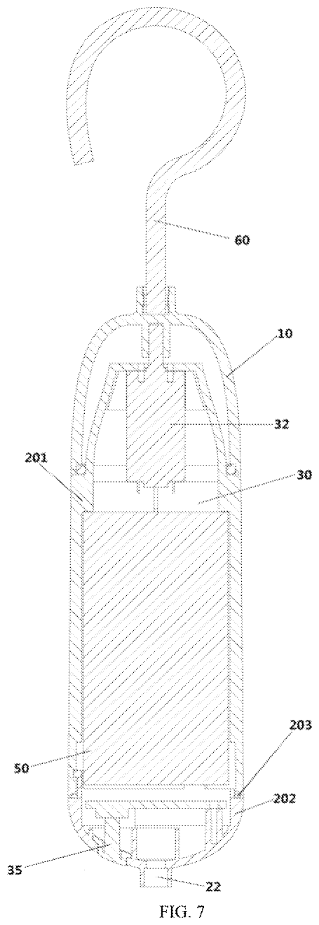

Referring to FIG. 6 to FIG. 7, the specific structures of Embodiment 2 of the present invention are shown. the mounting cavity 30 is disposed in the rotatable seat 20, which is disposed on a lower end of the fixed seat 10, and the lamp is disposed on a lower end of the rotatable seat 20.

Here, the drive unit includes a motor 32, and a drive end of the motor 32 is fixedly connected to the fixed seat 10, such that the rotatable seat 20 is rotatably disposed relative to the fixed seat 10;

and the power supply includes an accumulator battery 50 disposed within the mounting cavity 30, and the accumulator battery 50 supplies power to and is connected to the motor 32 and the lamp. Furthermore, a wire outlet 22 is formed in the rotatable seat 20, and the accumulator battery 50 is connected to the lamp by passing a conducting wire through the wire outlet 22. Similarly, the upper end of the fixed seat 10 is further provided with a hook 60 for a hanging purpose, and the fixed seat 10 is hung in the air by the hook 60. Preferably, the hook 60 is detachably connected to the upper end of the fixed seat 10, such that the fixed seat 10 may adapt to different hanging positions by the replacement of different specifications of hooks 60.

Further, the fixed seat 10 is cap-shaped, and is provided, at an inner side, with a plug adapted to the drive end of the motor 32. When the fixed seat 10 and the rotatable seat 20 are assembled, the lower end of the fixed seat 10 covers the upper end of the rotatable seat 20 (including covering an upper-end portion of the motor 32), thereby increasing the overall airtightness and appearance effect. Specifically, the drive end of the motor 32 and the plug may be fixed by glue bonding, a buckle structure or other means.

Further, the rotatable seat 20 includes an upper housing 201 and a cover 202 that is detachably connected to a lower end of the upper housing 201; the wire outlet 22 is formed in the cover 202; the upper housing 201 and the cover 202 may be detachably connected by a thread, a buckle, a screw, or other means. As a result, the design of the cover 202 facilitates a user in replacing the accumulator battery 50 or removing and charging the accumulator battery 50.

Preferably, a first seal ring is disposed between the cover 202 and the upper housing 201, and a second seal ring is disposed between the rotatable seat 20 and the fixed seat 10, thereby ensuring the overall airtightness. Meanwhile, the second seal ring increases the friction between the fixed seat 10 and the rotatable seat 20 to increase the operating stability.

Preferably, the rotatable seat 20 is further provided with a power button 35 for turning on or off the electrical connection between the accumulator battery 50 and the motor 32. Without doubt, the power button 35 may also be configured to simultaneously control the on or off of the electrical connection between the accumulator battery 50 and the motor 32 and between the accumulator battery 50 and the lamp. This relates to the prior art, and will not be described in detail here. Moreover, a master control board 31 for controlling and connecting the lamp and the motor 32 may also be disposed on the rotatable seat 20. The master control board 31 is correspondingly provided with an infrared receiving module or a wireless receiving module, such that a user may control the on or off of the rotatable lamp hanger (and the lamp) by a remote controller or a mobile phone.

Embodiment 3: This embodiment is substantially the same as Embodiment 1 in structure, with a difference in that the power supply supplies power to the accumulator battery 50 and is connected to the motor 32 and the lamp.

The design focus of the invention lies in mainly designing the rotatable lamp hanger to solve the technical problem of low ornamental value of a ceiling lamp at rest in the prior art is solved.

Then, the plurality of specific designs of the rotatable lamp hanger according to the invention solve the technical problem that the ceiling lamp during rotating causes the power cord to break; and furthermore, the invention is ingenious in structure, high in stability and easy to implement, which is conducive to popularization and application, showing considerable market prospects.

Moreover, the speed-reducing ring and a silicon ring are correspondingly designed to increase the airtightness and rotating stability of a product, thereby prolonging the service life and ensuring the safety in use.

Described above are merely preferred embodiments of the invention, and are not intended to limit the technical scope of the invention in any forms. Therefore, any tiny modification, equivalent variation and the like that are made to the above embodiments based on the technical essence of the invention shall still be included within the scope of the technical solutions of the invention.

What is claimed is:

1. A rotatable lamp hanger, comprising a fixed seat and a rotatable seat rotatably connected to the fixed seat, wherein a lamp is disposed on the rotatable seat, and the fixed seat or the rotatable seat is provided with a mounting cavity, in which a drive unit is disposed;
and further comprising a power supply that supplies power to the drive unit and the lamp, wherein when the drive unit works, the lamp is rotated under the drive of the rotatable seat that is driven by the drive unit.

2. The rotatable lamp hanger according to claim 1, wherein the mounting cavity is disposed in the fixed seat, the rotatable seat is disposed on a lower end of the fixed seat, and the lamp is disposed on a lower end of the rotatable seat; and wherein
the drive unit comprises a master control board and a motor that is controlled by and connected to the master control board, and the motor drives and is connected to the rotatable seat, such that the rotatable seat is rotatably disposed relative to the fixed seat; the power supply is an external power supply and is electrically connected to the master control board; and the master control board is electrically connected to the lamp.

3. The rotatable lamp hanger according to claim 2, wherein a first conductive element is disposed on the master control board, a second conductive element is disposed on the rotatable seat, and the lamp is electrically connected to the second conductive element; and wherein
the first conductive element is strip-shaped, the second conductive element is an annularly extending conductive element, the first conductive element is in butted contact with the second conductive element, and the first conductive element moves along an extending direction of the second conductive element when the rotatable seat rotates;
or, the first conductive element is an annularly extending conductive element, the second conductive element is strip-shaped, the first conductive element is in butted contact with the second conductive element, and the second conductive element moves along an extending direction of the first conductive element when the rotatable seat rotates.

4. The rotatable lamp hanger according to claim 3, wherein when the first conductive element is strip-shaped and the second conductive element is the annularly extending conductive element, the first conductive element comprises a first conductive piece and a second conductive piece which are disposed at an interval; the second conductive piece comprises a first conductive ring and a second conductive ring which are concentrically disposed; and the first conductive piece comes into contact with the first conductive ring and moves along an extending direction of the first conductive ring, and the second conductive piece comes into contact with the second conductive ring and moves along an extending direction of the second conductive ring; and
when the first conductive element is the annularly extending conductive element and the second conductive element is strip-shaped, the first conductive element comprises a third conductive ring and a fourth conductive ring which are concentrically disposed; the second conductive piece comprises a third conductive piece and a fourth conductive piece; and the third conductive piece comes into contact with the third conductive ring and moves along an extending direction of the third conductive ring, and the fourth conductive piece comes into contact with the fourth conductive ring and moves along an extending direction of the fourth conductive ring.

5. The rotatable lamp hanger according to claim 2, wherein a first conducting-wire hole is formed in the fixed seat, and the external power supply supplies power to and is connected to the master control board by passing a conducting wire through the first conducting-wire hole.

6. The rotatable lamp hanger according to claim 4, wherein a second conducting-wire hole is formed in the rotatable seat, and the second conductive element is connected to the lamp by passing a conducting wire through the second conducting-wire hole.

7. The rotatable lamp hanger according to claim 2, wherein the fixed seat comprises a first housing and a second housing, and the first housing and the second housing are connected by ultrasonic welding or by a buckle or by a screw to form the mounting cavity.

8. The rotatable lamp hanger according to claim 1, wherein the mounting cavity is disposed in the rotatable seat, the rotatable seat is disposed on a lower end of the fixed seat, and the lamp is disposed on a lower end of the rotatable seat; wherein
the drive unit comprises a motor, and a drive end of the motor is fixedly connected to the fixed seat, such that the rotatable seat is rotatably disposed relative to the fixed seat;
and the power supply comprises an accumulator battery disposed within the mounting cavity, and the accumulator battery supplies power to and is connected to the motor and the lamp; and a wire outlet is formed in the rotatable seat, and the accumulator battery is connected to the lamp by passing a conducting wire through the wire outlet.

9. The rotatable lamp hanger according to claim 8, wherein the rotatable seat comprises an upper housing and a cover that is detachably connected to a lower end of the upper housing, and the lamp is disposed on the cover.

10. The rotatable lamp hanger according to claim 1, wherein the mounting cavity is disposed in the rotatable seat, the rotatable seat is disposed on a lower end of the fixed seat, and the lamp is disposed on a lower end of the rotatable seat; wherein
the drive unit comprises a motor, which drives and is connected to the fixed seat, such that the rotatable seat is rotatably disposed relative to the fixed seat; and the power supply is an accumulator battery, and supplies power to and is connected to the motor and the lamp.
